(19) United States
(12) Patent Application Publication
(10) Pub. No.: US 2006/0095347 A1
(43) Pub. Date: May 4, 2006

(54) Software application for inventory data collection, validation and consolidation

(76) Inventors: Robert J. Melucci, San Diego, CA (US); Steven C. Hernandez, San Diego, CA (US); Roger J. Wellington-Oguri, San Diego, CA (US); Wilfred K. Sakai, Poway, CA (US)

Correspondence Address: AKIN GUMP STRAUSS HAUER & FELD, LLP, P O BOX 688, DALLAS, TX, 75313-0688, US

(21) Appl. No.: 10/981,257

(22) Filed: Nov. 3, 2004

(51) Int. Cl. A01K 5/02; G06F 17/50

(52) U.S. Cl. 705/28; 705/29

(57) ABSTRACT

A software application includes program codes for executing a plurality of steps for collecting, processing and validating inventory data by a computer. The software application is used for maintaining accurate stock keeping information of a retail store, a warehouse or of any other location where inventory is stored. The software application can be incorporated into a hand-held computer or any other computer configured to take physical inventory of merchandize. The application includes a download data module configured to receive selected background information required to process the inventory data being collected by the computer. The application also includes a parameterization module configured to create data structures for the collection of inventory data, and a data capture module configured to collect records of inventory data. The application includes a reporting module configured to generate reports of the collected inventory data, and an upload module configured to transmit collected inventory data.

### TECHNICAL FIELD

The present invention relates to inventory data, and more specifically, to a software application for inventory data collection, validation and consolidation.

### BACKGROUND OF THE INVENTION

Accurate inventory information is vital to the success of businesses engaged in the sales of goods and merchandise. A business such as a retail store, must maintain a reasonably accurate inventory, which is essential to meet the demands of its customers. If the retail store is able to meet the demands of the customer by maintaining a reasonable level of inventory, the retail store earns a profit from the sale of that merchandise. The retail store also increases the likelihood that the customer will return to shop. In contrast, if the retail store is out of one or more items, customers seeking the item will be disappointed. A disappointed customer will most likely shop at another store, and the retail store will lose the customer's purchase. Furthermore, the retail store may lose the customer in the long-term because the customer may conclude that a well-stocked store can better meet their needs.

The inventory can also be items that is not for sale. For example, the inventory can be a company's fixed assets. The company may find it necessary to keep accurate information about the inventory of its fixed assets during the ordinary course of its business.

In a retail store, when an item is sold, the inventory level of the item decreases. The retail store typically re-stocks the item before the inventory level becomes too low or the store completely runs out of the item. In order to be able to restock the item before the inventory level gets too low, the retail store must monitor the inventory regularly. In fact, most retail stores must monitor the inventory frequently to ensure that they have sufficient supplies to meet the regular demands of the customer.

Typically, a retail store keeps its inventory information stored in a computerized system. The system generally tracks shipments received and inventory sold. The system detects errors in inventory levels due to customer or employee theft, shipping or receiving errors, and product mislabeling. In order to monitor the inventory accurately, an employee or some other individual must periodically physically count each item to validate the computerized inventory information. However, in large retail stores that stock hundreds of thousands of items, it is difficult for a retailer to manually count the items and collect the inventory data. Special devices are often used to count the items stacked on shelves.

Retail stores often contract with a service provider to collect and consolidate their inventory data. The service provider usually has operators that use specialized computers or other hand-held machines to collect the inventory data. Outside services are also used to provide an independent opinion of the inventory levels for financial reporting purposes.

The inventory data must be validated and consolidated after it is collected. The inventory information must also be reported for subsequent analysis. Conventional computers and other hand-held machines (referred hereinafter as “computers”) for collecting inventory data require software applications that allow them to collect and validate inventory data. The computers also require software applications to consolidate and report inventory data.

The computers designed to collect inventory data lack software applications for efficient collection and validation of inventory data. Conventional computers also lack software applications for efficient consolidation and reporting of inventory data, and lack software applications to perform complex inventory data manipulation, validation and consolidation at a high speed.

Accordingly, there is a need for a software application that allows efficient collection and validation of inventory data. There is also a need for a software application that allows efficient consolidation and reporting of inventory data, and performs complex inventory data manipulation, validation and consolidation at a high speed.

### SUMMARY OF THE INVENTION

The present invention is directed to a software application having program codes for executing a plurality of steps for collecting, processing and validating inventory data by a computer. The software application is used for maintaining accurate inventory information of a retail store, warehouse or of any other location where inventory is stored. The software application can be incorporated into a hand-held computer or any other computer configured to take physical inventory of merchandize or other items.

The application includes a download data module configured to receive selected background information required to process the inventory data being collected by the digital computer. The application also includes a parameterization module configured to create data structures detailing the collected inventory data, and a data capture module configured to collect records of inventory data. The application includes a reporting module configured to generate summary reports of the collected inventory data, and an upload module configured to transmit collected inventory data to a host computer.

The selected background information includes validation tables that define data fields to be captured and the data fields' attributes. The selected background information includes prior inventory data used to compare totals from a previous inventory to the current inventory. The parameterization module defines validations to be performed on the data fields.

The application generates cumulative totals of the price, cost and quantity of the inventory. The application further includes a data consolidation module configured to operate the digital computer in a host mode, wherein the digital computer receives and processes inventory data collected by a plurality of other computers in the counting mode.

The upload module is configured to transmit collected inventory data, employee time data and computer usage history logs to a host computer. The upload module transmits the data using infra red, wireless, the Internet or any other communication link.

### BRIEF DESCRIPTION OF THE DRAWINGS

FIG. 1 is a functional block diagram of various software modules of the software application in accordance with one embodiment of the invention.

FIG. 2 is a flow diagram of the steps performed by the software application during counting mode in accordance with one embodiment of the invention.

FIG. 3 is a flow diagram of the steps performed by the software application in a data consolidation mode in accordance with one embodiment of the invention.

### DETAILED DESCRIPTION OF PREFERRED EMBODIMENTS

The various features and methods of the invention will now be described in the context of inventory data collection, validation and consolidation. Those skilled in the art will recognize that the invention is applicable to other types of data collection.

Throughout the description of the embodiments, implementation-specific details will be given on how the invention is used to efficiently collect, validate and consolidate inventory data. These details are provided to illustrate the preferred embodiments of the invention and not to limit the scope of the invention. The scope of the invention is set in the claims section.

In one embodiment, the invention is a software application that processes and maintains accurate inventory information. The software application can be incorporated into a personal data assistant (PDA), tablet PC, a hand-held computer, or any other type of computer. In a preferred embodiment, the software application is implemented in a hand-held computer for efficient collection and validation of inventory data.

The inventory data is typically collected in a retail establishment or a warehouse where a physical inventory of merchandise is required to be taken. The merchandise is typically stored on shelves or stacked in another manner. An operator typically takes a physical count of the merchandise. The operator may be an employee of the retail establishment or may be employed by an entity that specializes in taking physical inventories for retail establishments and other businesses. The operator may collect the inventory data as part of a regular audit of the inventory, or as part of a snapshot status check of the physical inventory. The software application is implemented in a hand-held computer that is used by the operator to efficiently collect and validate the inventory data.

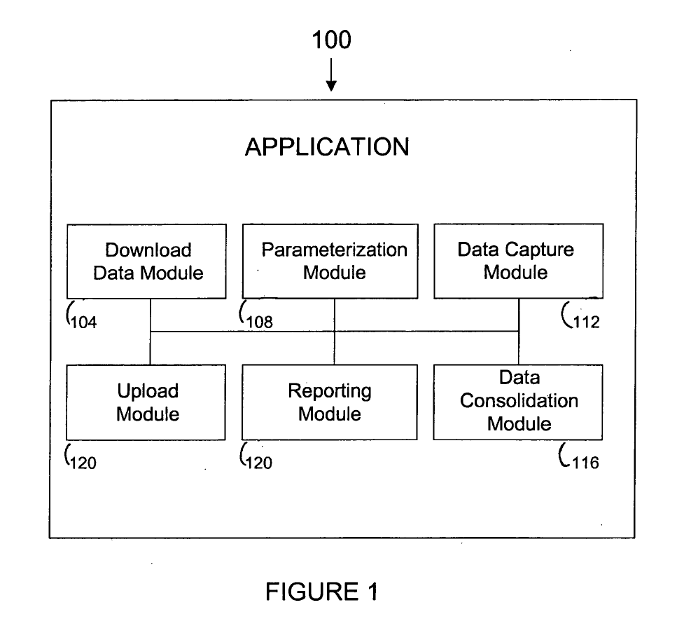

FIG. 1 is a functional block diagram of various software modules of a software application 100 in accordance with one embodiment of the invention. The software modules include program codes for executing one or more steps or functions. The software modules can be written in any known programming language such as, for example, C, C++ or assembly language. The software modules can also be written in Visual Basic and compiled into an object code format also known as pseudo-machine code (p-code). In one embodiment, the software application is configured to run on a Microsoft Windows CE operating system.

Referring now to FIG. 1, the application 100 includes a download data module 104. In one embodiment, the download data module 104 is used to download or transfer validation tables, prior inventory data, plug-in reports and time of day.

A validation table is generally loaded into the hand-held computer prior to capturing inventory data. The validation table defines what data fields will be captured. Data fields may include stock keeping unit (SKU), Universal Product Code (UPC), cost, etc. The validation table also defines each field's attributes such as length, allowed barcode types, and validations to be performed on the collected inventory data.

Prior inventory data can also be loaded into the computer in order to produce reports that compare the totals from a previous inventory against the current inventory. Plug-in reports contain custom logic to summarize the inventory data captured by a terminal in a format specified by a customer.

In one embodiment, a validation table can be serially downloaded from a PC, serially crossloaded from another computer, or imported from a data card. A validation table can also be written to a PCMCIA data card by a PC or exported from the computer's internal memory to a data card. Prior inventory data and plug-in reports can be downloaded from MTAPS (Modem Transmission Automated Processing System). Once downloaded, prior inventory data and plug-in reports can be crossloaded between computers using IR (InfraRed) transmission.

The application 100 also includes a parameterization module 108. The parameterization module 108 creates data structures referenced during data capture. The parameterization module 108 defines which data fields will be captured, the attributes of those data fields and what validation will be performed on the individual fields in a data record. In one embodiment, the parameterization table is compiled into a binary file that is customized for a customer's specific inventory-taking needs.

In one embodiment, a Data Entry Table is created using attributes from the validation table in combination with operator input. Some of the attributes from the validation table include: data fields to be captured, data field names (e.g., “UPC”), totals fields to be tracked (i.e. price/cost/quantity), allowable field lengths, fixed or variable field lengths, numeric or alphanumeric data allowable, should leading zeroes be stripped, check digit validation algorithms (if any), allowable barcode symbologies (if any), scannable field lengths, table lookups/nested table lookups (if any), should fields be double-keyed, perform cost less than price validation, etc.

In one embodiment, a global parameterization table is created during parameterization. The global parameterization table includes string data taken from the validation table and also data entered by the operator. The fields of the global parameterization table include the computer's Unit ID, posting sheet number, worksheet (inventory) number, account number, store number and date.

In one embodiment, during parameterization, some variables are initialized. For example, variables that are initialized are accumulator total indices (i.e. price, cost, quantity), an item detail/financial mode flag, a ‘minus sections allowed’ flag, a ‘round dollar totals’ flag, a ‘capture unique SKU count’ flag, etc.,

In one embodiment, the application 100 collects 12 discrete fields in each data record. These fields are Section and Area (e.g., location information), Breakdown/Department (e.g., category information), six item detail fields (sometimes referred to as SKU, Class, Age, Style, Size, Color), Price, Cost (or alternately, unique SKU count), and Quantity. Each record field, particularly item detail fields, can contain a large amount of data that may describe much more than a single property of an item.

In one embodiment, parameters are stored in a validation table, which is customized for a customer's specific inventory-taking needs. The validation table includes: data fields to be captured, total fields to be tracked (i.e., price/cost/quantity), those fields' names (ex. “UPC”, “retail”), allowable field lengths, numeric/alphanumeric data allowable, should leading zeroes be stripped, check digit validation algorithms (if any), allowable barcode symbologies (if any), scannable field lengths, table lookups/nested table lookups (if any), should field lengths be double-keyed, cost less than price validation, etc.

The parameters defined in a validation that are applicable for an item detail mode inventory are: dollar totals yes/no, piece totals yes/no, minus sections allowable, field attributes (see Data Entry table above) for the following fields: Section, Area, Breakdown, Item detail fields 1-6, Price, Cost and Quantity, custom checkdigit algorithm attributes, Top Of Loop field number, default transmission format, terminal unit ID, posting sheet number, worksheet (inventory) number, account number, store number and date.

Generally, most of the parameters defined in a validation table are preset before the validation table is loaded into the computer. Alternatively, an operator may enter the parameters.

In one embodiment, the validation tables are account-specific, but not store-specific or date-specific. Consequently, the application 100 may prompt the operator to enter the store number and date during parameterization.

The application 100 also includes a data capture module 112. The data capture module 112 collects data records and keeps running totals of cumulative price, cost, quantity, and number of unique SKUs. The selected validation table defines the data fields to be captured and the format of the data to be entered into each field. The validation table also dictates which cumulative totals should be tracked.

An example of a captured data record is shown below.

| Data record | |
|---|---|
| Section | 1000 |
| Area | 1 |
| Breakdown | 20 |
| SKU | 123456789012 |
| Class | 55 |
| Age | 67 |
| Style | AB |
| Size | 34L |
| Color | Red |
| Price | 2.00 |
| Cost | 1.00 |
| Quantity | 3 |

As defined by the validation table, the application 100 typically tracks Price and/or Cost and Quantity. In one embodiment, a cost accumulator can also be used to track the number of unique SKUs in a Section/Area/Breakdown.

In one embodiment, totals for Price, Cost (or alternately Unique SKU count) and Quantity are tracked by Section, Area and Breakdown. For example, Quantity totals are tracked as: Grand Quantity Total, Section Quantity Totals, Breakdown Quantity Totals, Section/Area Quantity Totals, Section/Breakdown Quantity Totals and Section/Area/Breakdown Quantity Totals.

In one embodiment, account-specific custom logic is bundled in the validation table. The logic allows customization of the treatment of data format, data validation, and data extraction. For example, using a customer-supplied masterfile of valid SKU numbers and prices in a store, the logic can verify that the SKU number entered by the operator is in the list of valid SKU numbers. The associated masterfile price can be extracted into the price field eliminating the need for the operator to key the price. A script can be used to provide logic based on the SKU number entered, which prompts the operator to enter additional information into subsequent fields or skip entering additional information into subsequent fields.

In one embodiment, edit functions allow captured data and totals to be reviewed and modified. Utility functions such as audit mode and pop-up calculator mode allow the operator to double-check their count without affecting any inventory data that has already been collected.

An audit mode is used to verify Price/Quantity entries. The audit data does not become part of the inventory data. In audit mode, the operator enters a price and a quantity. In one embodiment, the plus and times keys of the computer can be used to build a quantity.

In one embodiment, the application 100 provides a pop-up calculator function that is a simple four-function scratchpad calculator to add, subtract, multiply and divide. The calculator also provides a memory function. The value in the memory can be added to and subtracted from. The operator has the option to operate on the value held in the memory instead of entering a new value.

The application 100 also includes a data consolidation module 116. The data consolidation module 116 allows the application 100 to be operated in a host mode. In the host mode, the application collects and processes inventory data from other computers that are in a counting mode.

In one embodiment, in the host mode the application 100 can operate in a super collector mode or in a data harvester mode.

The super collector mode is generally used when the operator uses the computer (e.g., hand-held computer) to take the place of a host computer in small inventories. In the super collector mode, a small amount of data is generally collected and is uploaded to the host computer. The data harvester mode is generally used in large inventories to collect data from a large number of counting computers and ferry the data to the host computer. In the data harvester mode, the computer can hold hundreds of transmissions on a data card (e.g., 4 MB to 128 MB data card). The application 100 can produce reports summarizing the accumulated count data in the super collector and data harvester mode.

After super-collection (e.g., receipt of financial data from another terminal), the data received from the sending computers appears as if it was entered into the super-collector computer. The data harvested and super-collected data is eventually uploaded to a host system for processing, if required, and archiving.

The application 100 also includes a reporting module 120. The reporting module prints reports such as a section summary report, a department summary report, a section/area/department summary report, a data harvester section summary report, an electronic time collection summary report, etc. Additionally, account specific, custom plug-in reports can be downloaded by the application 100 as dynamic link libraries (DLL). Report output can be sent to a printer via a serial or IrDA communication link. The report output can also be displayed on the LCD or output to a data file.

In one embodiment, the application 100 includes a plug-in report that implements a single custom report. The plug-in report is a software module written in C++and housed in a Win32 Dynamic Link Library (DLL).

The application 100 also includes an upload module 124. The upload module 124 transmits captured inventory data, employee-time sheet data and terminal usage history logs via serial, IrDA, modem, or wireless communication to a host system.

The employee time sheet data consists of clock-in and clock-out records that contain time punches and document employees clocking in and out of inventory job-codes such as counter, crew manager, auditor, travel-driver, travel-passenger, and unpaid break.

The terminal usage history is a log of activities occurring on the computer. New activities are constantly being recorded, overwriting the record of older activities once the log fills up. When an error occurs in the computer, additional information about the current state of the computer is recorded and the history log is uploaded from the computer. The history log provides information as to the cause of any errors that occur on the computer. The history log contains as complete as possible a picture of the events that led up to the error and the state of the computer when the error occurred.

The host system may be an in-store PC, a hand-held computer in super-collector or data harvester mode or any other computer. The upload module 124 can also upload inventory data to a customer's computer system.

In one embodiment, the application provides two modes of operations: a counting mode, and a data consolidating host mode.

In the counting mode, the application 100 downloads information, processes collected data and uploads data to a host system. In the host mode, the application 100 receives inventory data transmitted by other computers and aggregates the data for further analysis and archiving.

A data capture loop collects inventory data records and keeps running totals (e.g., cumulative price, cost, quantity, and ‘number of unique SKUs’ totals). A data record may include fields such as Section (e.g., store aisle), Area (e.g., one of the gondolas that comprise the aisle), Breakdown (e.g., category such as dairy, housewares, toiletries, etc.), SKU (e.g., UPC), price, cost and quantity (i.e., number of like items on the shelf).

The data harvester and super collector modes allow data from other computers to be transmitted to a computer acting as a host computer. The data collected is then transmitted to an in-store PC or MTAPS for processing and archiving, if required.

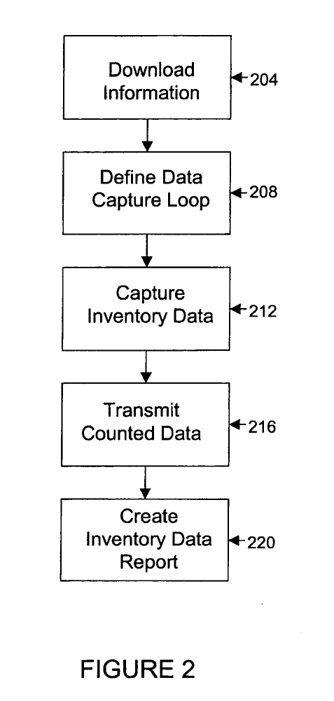

FIG. 2 is a flow diagram of the steps performed by the application 100 during the counting mode in accordance with one embodiment of the invention. In step 204, the application downloads various information including validation tables, prior inventory data, and plug-in reports.

In step 208, selected validation tables and account-specific parameterization is used to define the behavior of a data capture loop. The parameterization sets up the internal data structures that drive subsequent data capture. The parameterization dictates which data fields will be captured, those field's attributes and what validation will be performed on the individual fields in a data record. For example, one account (i.e., customer) may require that the computer capture a large amount of information regarding each item in their store (e.g., SKU, Class, Age, Style, Size, Color, Price, Cost and Quantity). Another account may only require that the computer capture SKU and Quantity. Another account may not be interested in capturing any item detail information and only require dollar totals (e.g., Price times Quantity).

In step 212, inventory data is captured in a manner dictated by the selected validation tables and operator parameterization, and the data is counted. In step 216, the count data is transmitted or uploaded to a host system. Also, the computer usage history and error log is transmitted or uploaded.

In step 220, a report of the inventory data is generated. The report may be a standardized summary report. Also, a customized account specific plug in report can be invoked.

In the data harvester host mode, the application 100 receives data from many operators collecting inventory data using individual computers. In the data harvester mode, the application 100 is used to collect inventory data from other computers that are in a ‘counting mode’.

The counting computers transmit the inventory data to the data harvester computer (i.e., the computer in the data harvester mode) using either a serial cable, IR or other transmission links. The collected inventory data can either be saved in an internal memory or stored on a PCMCIA data card. The collected inventory data can then either be transmitted to a host computer or the data card can be removed from the data harvester computer and the harvested transmissions can be uploaded through a reader/writer slot into the host computer.

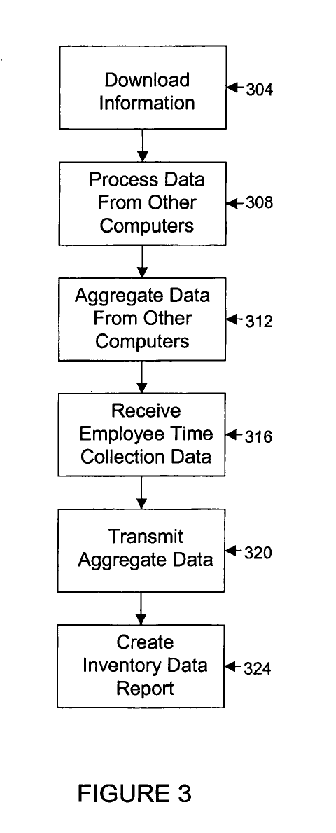

FIG. 3 is a flow diagram of the steps performed by the application 100 in the data harvester mode. In step 304, prior inventory data, plug in reports and time of day are downloaded. In step 308, inventory data transmitted from other computers is processed. In step 312, inventory data received from other computers are aggregated.

In step 316, employee time collection data is received. The employee time data is generated when employees clock in and out of inventory events. Employees may wear an ID badge that has a barcode identifier. When an employee arrives or leaves, the badge may be scanned or employee information can be keyed in to create a time card punch. In step 320, super collected financial inventory data, harvested inventory data and employee time data are transmitted or uploaded into the host computer. In step 324, a report of the inventory data is generated.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A software application having program codes for executing a plurality of steps for collecting, processing and validating inventory data by a computer, the software application being used for gathering accurate inventory information, comprising:
a download data module configured to receive selected background information required to process the inventory data being collected by the computer;
a parameterization module configured to create data structures for the collection of inventory data;
a data capture module configured to receive data records of the collected inventory data;
a reporting module configured to generate reports summarizing the collected inventory data;
an upload module configured to transmit the collected inventory data.

2. The software application of claim 1 wherein the selected background information includes validation tables that define data fields to be captured and the data fields' attributes.

3. The software application of claim 1 wherein the selected background information includes prior inventory data.

4. The software application of claim 3 wherein the prior inventory data is used to compare totals from a previous inventory to the current inventory.

5. The software application of claim 1 wherein the parameterization module defines the validation to be performed on data fields.

6. The software application of claim 1 wherein the data capture module is configured to generate cumulative totals of the price, cost and quantity of the inventory data.

7. The software application of claim 1 further comprising a data consolidation module configured to operate the computer in a host mode.

8. The software application of claim 7 wherein the computer operating in the host mode receives and processes inventory data collected by a plurality of other computers in a counting mode.

9. The software application of claim 7 wherein the host mode includes a data harvester mode.

10. The software application of claim 1 wherein the reporting module is configured to print summaries of captured data.

11. The software application of claim 1 wherein the upload module is configured to transmit collected inventory data to a host computer.

12. The software application of claim 11 wherein the upload module transmits employee time data and computer usage history logs to the host computer.

13. The software application of claim 12 wherein the upload module transmits the data using infra red transmission.

14. The software application of claim 12 wherein the upload module transmits the data using wireless communication.

15. The software application of claim 12 wherein the upload module transmits the data using the Internet.

16. A method for collecting, processing and validating inventory data collected by a plurality of computers using a software application having program codes for executing a plurality of steps, comprising:
collecting inventory data by a plurality of first computers in a counting mode;
transmitting the collected inventory data by the plurality of first computers;
receiving the inventory data by a second computer in a host mode;
processing the inventory data by the second computer;
generating reports of the inventory data.

17. A method for collecting, processing and validating inventory data, comprising:
receiving validation tables and selected background information;
creating parameterization for the inventory data capture from the selected background information;
collecting the inventory data in accordance with the parameterization;
generating a report of the inventory data.

18. The method of claim 17 further comprising:
collecting inventory data by a plurality of first computers in a counting mode;
receiving the collected inventory data at a second computer in a host mode;
aggregating the inventory data by the second computer.

19. The method of claim 17 wherein the parameterization defines fields of the inventory data and the fields' attributes.

20. The method of claim 17 wherein the parameterization defines validations performed on the data fields.
